(19) United States
(12) Patent Application Publication
(10) Pub. No.: US 2008/0231893 A1
(43) Pub. Date: Sep. 25, 2008

(54) Method, Software Program Product and Device For Producing Security Documents

(76) Inventor: Hans Peter Kraus, Bavaria (DE)

Correspondence Address: APEX JURIS, PLLC, 12360 LAKE CITY WAY NORTHEAST, SUITE 410, SEATTLE, WA, 98125, US

(21) Appl. No.: 12/067,932

(22) PCT Filed: Sep. 25, 2006
(86) PCT No.: PCT/EP2006/009290

§ 371 Date: Mar. 24, 2008

(30) Foreign Application Priority Data
Sep. 24, 2005 (DE) 10 2005 045 816.5

(51) Int. Cl. G06F 21/22; H04N 1/44

(52) U.S. Cl. 358/1.15; 358/3.28

(57) ABSTRACT

The present invention relates to a method for producing security documents, a software program product and a corresponding device. In order to further develop a method for producing security documents, wherein a decision maker communicates with at least one printer via a personalisation server sub-centre, as well as a corresponding computer program product and a corresponding device with significantly improved operating security, it is suggested that the at least one printer (D) only executes a printing order (Ordr) after receiving a reply (R) to at least one verification enquiry (A) whose correctness is confirmed.

The present invention relates to a method for producing security documents, a software program product and a corresponding device.

Security documents such as, for example identity cards or passports, are today provided at least with one security feature which is selected from a large plurality of different security features. Without restricting the field of application, only security documents in the form of passports are discussed hereinafter to describe the invention.

However, the invention can also be applied to chip cards such as they are used in various designs as access authorisation proof or in the mobile telephone and/or pay-TV area. Another field of application is the application of so-called product security features which, for example, can be attached as labels or seals to packages and/or a respective product itself. Product security features are used on the one hand as an authenticity and quality feature but on the other hand are being used for logistics purposes in the wider sense, in particular for material flow and/or warehouse control or as protection against theft in warehouses or department stores.

According to the prior art, at least one device for printing, embossing, punching, laser treatment or for implementing one or several similar methods is provided for attaching at least one of a plurality of different security features on, at and/or in a security document. Without restriction, these individualising or personalising devices are hereinafter combined under the term “printer”. Devices having a modular structure and closed in themselves, are known from a plurality of documents for constructing security documents. At least one printer is used herein together with sheet and positioning as well as transporting and storage devices. Systems of this type print and fabricate security documents under monitoring by a computer unit as a control unit. A feature common to all known systems is that usually a completely finished and personalised security document is output at the end point which is protected against forgeries and/or adulterations to a respectively predefined extent.

However, it has been found that even an installation of systems of this type in high- and maximum-security zones on site can only be inadequately protected against misuse. This particularly applies to smaller systems in a spatially confined environment. As an example of this, reference should be made to the conditions during the issuing of visas and travel documents in embassies or general agencies of individual countries in a foreign country.

It is thus the object of the present invention to further develop a method for producing security documents, wherein a decision maker communicates with at least one printer via a personalisation server sub-centre, as well as a corresponding computer program product and a corresponding device with significantly improved operating security.

This object is achieved by the features of the independent claims. Accordingly, a method according to the invention for producing security documents is characterised in that at least one printer only executes printing instructions after receiving a reply to at least one verification enquiry whose correctness is confirmed. A corresponding device is accordingly characterised in that a printer is provided with monitoring intelligence as means for triggering an authorisation enquiry in response to an incoming print order. It is thereby ensured for the first time according to the invention that a printer as a highly specialised device for end processing of a security document can in no way be set in operation in an unauthorised manner by connecting it to an externally acting computer or another unauthorised data input unit for specifying print data. The legitimacy of a respective print instruction is now checked for which a self-contained method is provided. The operating security of a device for producing security documents is thereby considerably increased because only authorised print orders can be processed and any influencing from outside is better eliminated.

By means of a computer program product according to the invention, a data processing system which can also comprise distributed external components, is enabled to execute a method in which each incoming print order for producing a security document is checked with regard to its authorisation by at least one individualising or personalising device, in particular by checking that a receipt of a reply received to at least one verification or authorisation enquiry is correct.

Advantageous further developments of the invention are the subject matter of the respective dependent claims. Thus, in a preferred embodiment of the invention, an authorisation enquiry is sent by a security circuit or intelligence for each print order received individually at the printer. The authorisation enquiry is preferably directed to a personalisation server sub-centre. The personalisation server sub-centre must respond to this authorisation enquiry with a reply which, in one embodiment of the invention, is then checked together with the authorisation enquiry by the intelligence inside the printer to individually ensure an authorisation for granting a print order. A respectively pending individual print order is only executed by the printer in the event of a positive test result. In an alternative embodiment of the invention, the authorisation enquiry is sent to a superordinate decision maker and must be answered correctly there, which is again checked at the printer selected for execution.

In a particularly advantageous embodiment of the invention, a boundary between a decision maker or a government towards the units which subsequently execute the print orders is formed by a computer. In a preferred embodiment, this computer takes over the function of a proxy server and creates an adaptation between an individual port with regard to software, data formats, databases, encryption etc. to a decision maker or a government on the one hand and a standardised system on the other hand.

Further features and advantages of embodiments according to the invention are explained in detail hereinafter with reference to exemplary embodiments in the drawings. The drawings show:

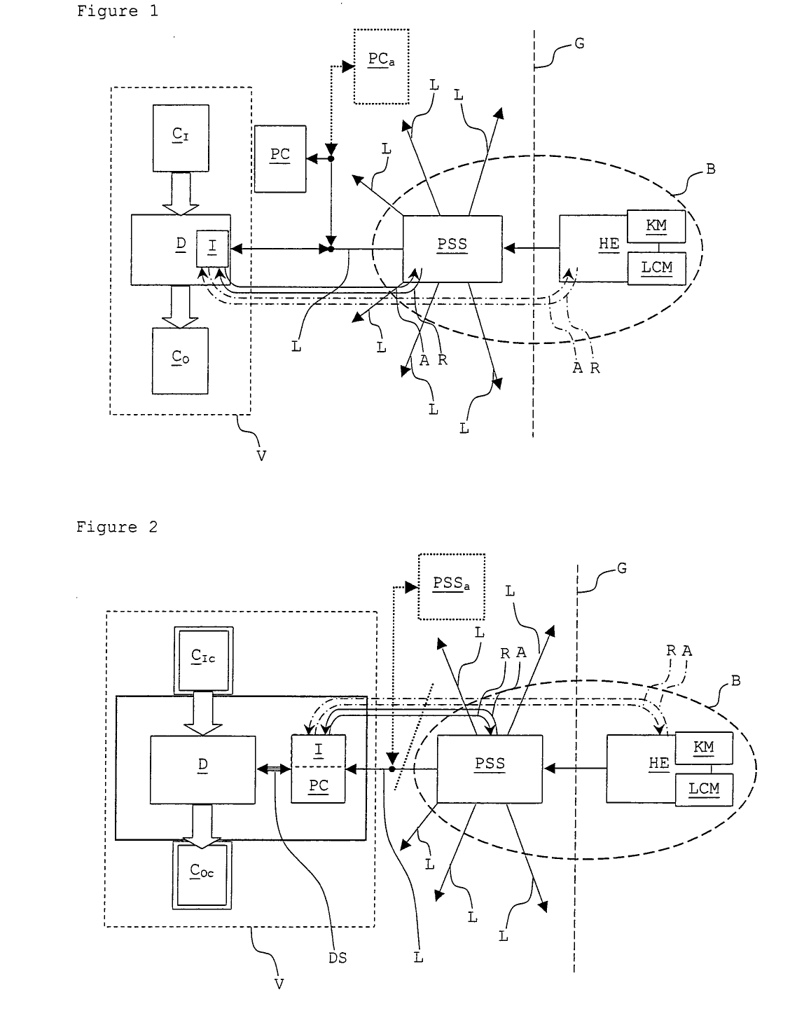

FIG. 1: a schematic diagram of a first embodiment of a device according to the invention showing an unauthorised access attempt;

FIG. 2: a block diagram similar to the diagram in FIG. 1 to illustrate a second embodiment with additional security features against unauthorised access;

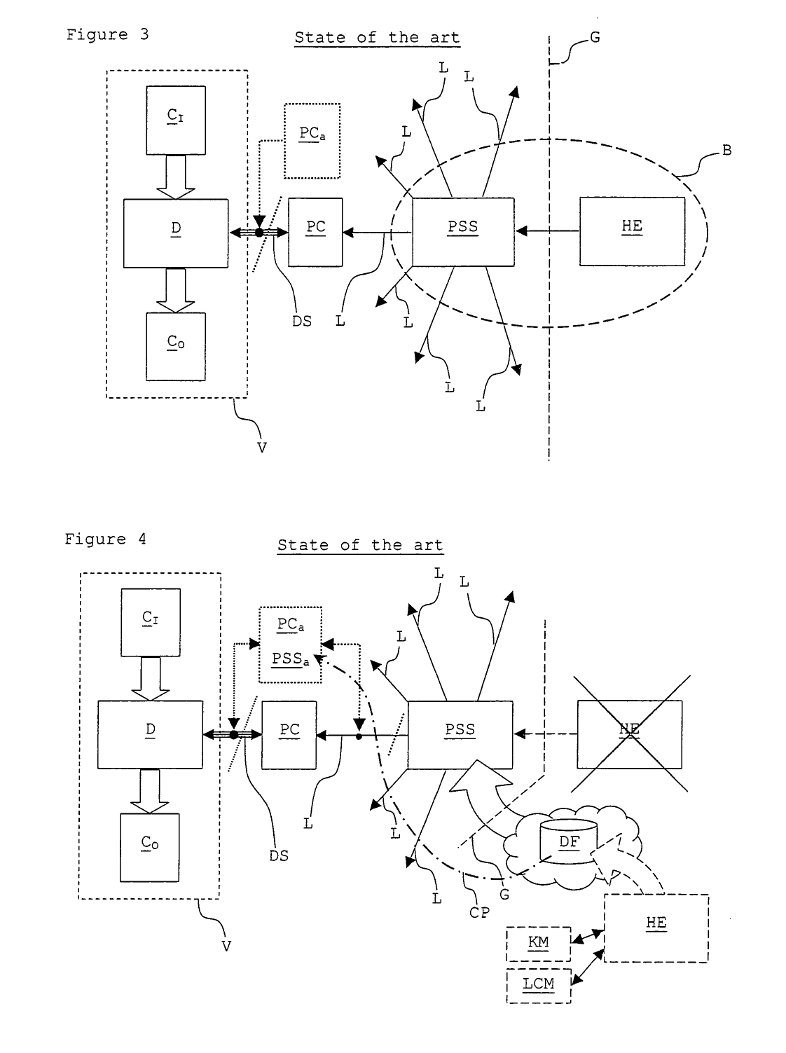

FIG. 3: a block diagram to show a basic structure of a device according to the prior art;

FIG. 4 a block diagram to show a further known device and

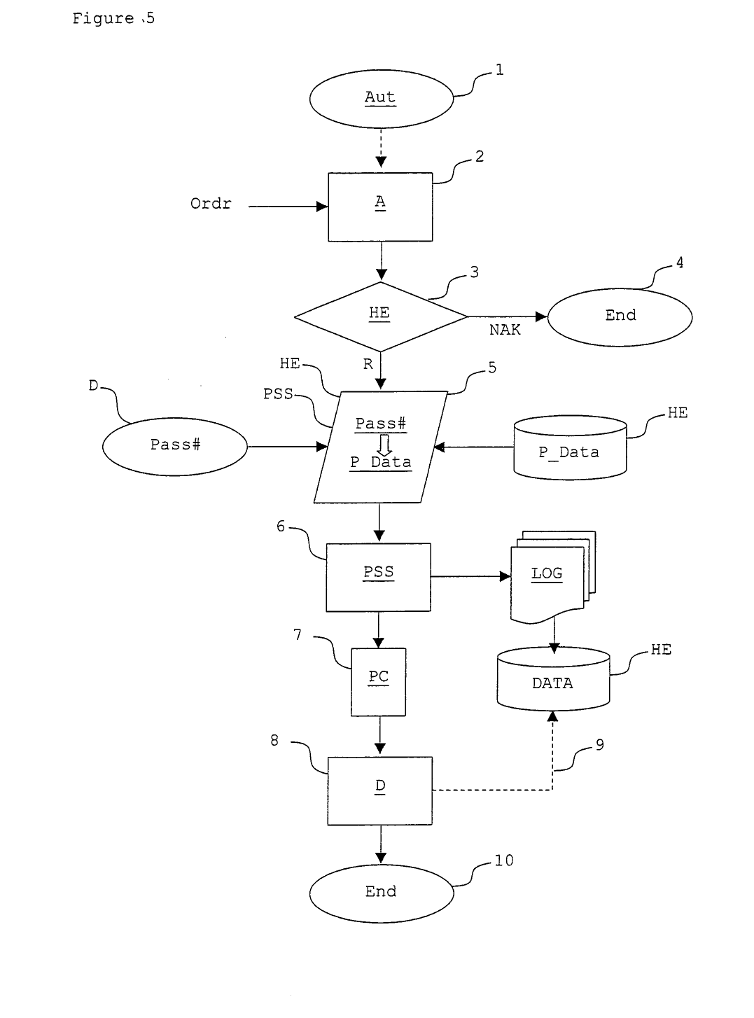

FIG. 5 a flow diagram of subprocesses in individual components of a device according to the invention for issuing a security document.

The same reference numerals are always used for the same elements throughout the various figures. Without restricting the invention to this field of application, the production of security documents in the form of passports and identity documents is discussed mainly hereinafter.

The prior art in this field will first be discussed. For this purpose, in a block diagram FIG. 3 shows a basic structure of a device known from the prior art for producing passports and travel documents. The data of all persons for whom identity documents can be created in a permissible manner are present at a decision maker HE which is provided by a government of a country or an authorised personalisation centre. In addition, respectively defined number and/or code spaces for the various security features of the identity documents are provided at the decision maker HE separated from the personal data. The scope of protection or the type and number of different protection features which an identity document is to have is thus specified at this point. For a print order these data are sent by the decision maker HE to a personalisation server sub-centre PSS, passing through a boundary G from the decision maker towards the units which subsequently execute the print orders.

From the personalisation server sub-centre PSS as a central distributor point, corresponding print orders can be distributed to a plurality of local printers, which is indicated in FIG. 3 by the arrows leading away from the centre PSS. Each of the arrows represents a LAN or internet connection whose end point is a control system PC for a respectively following individualising or personalising device D, hereinafter designated for simplicity as printer. The control system PC and the printer D are connected to one another via a line DS for data exchange in both directions.

It is thus possible that the printer D as part of a complete personalising device V receives prepared security documents from a storage device C_{I} via supply means, provides these with security features and the respective personal data in a manner specified by the decision maker HE before subsequently delivering these to a storage device C₀ for ready-processed security documents. Within the framework of this processing process, the printer D can initially read out an individual number of a prepared security document and send this via the printer interface DS for checking or further dispatch to higher authorisation layers to the system controller PC. Individual passport data can then be linked to a respective person, for example, in the decision maker HE.

In known systems the printer interface DS is usually a hardware connection which is not further protected, which can also be embodied in the form of a parallel standard printer cable with a Centronix interface or as a USB connection. Accordingly, the printer interface DS is very well suited for a non-authorised intervention. For this purpose, the connection between the printer D and the system controller PC can be separated or interrupted in the manner shown in FIG. 3. Instead of the system controller PC located in the authorised data and processing track, an unauthorised intervening printer control system PCₐ is inserted subsequently. Changing over cables is already sufficient for this purpose. If the authorised system controller PC is correspondingly exactly emulated by the non-authorised system controller PCₐ, none of the components D, C_{I}, C₀ inside the personalising device V can notice this unauthorised intervention. In particular, the printer D will now produce any arbitrary security document or an arbitrary number of passports for any persons under instruction by the unauthorised printer controller PCₐ. Whereas in the structure according to FIG. 3 both the decision maker HE and the personalisation server sub-centre PSS form external units whose lines and data communication are to be protected against adulteration and unauthorised intervention by coding and similar measures in a manner known per se, only the control system PC is located on site or directly adjacent to the personalising device V with the printer D.

An approach reproduced in the block diagram in FIG. 4 is known from the field of smart card production for cash and credit cards as well as code cards for pay television or pay-TV and mobile telephones. Here a direct connection of a decision maker HE to a personalisation server sub-centre PSS is omitted. Rather, all the data and formats and their allocation to respectively released number and/or code spaces are supplied in the form of fixedly allocated data and format sets DF as a finished file to the personalisation server sub-centre PSS. As an extension to the diagram in FIG. 3, in the exemplary embodiment of FIG. 4, which is also known from the state of the art, a key management KM and a life cycle management LCM are arranged at the decision maker HE which co-determine the result in the form of finished data and format sets DF. Again any personalising devices V in distributed locations can be addressed by the personalisation server sub-centre PSS. As far as obtaining ready processed security documents in a collecting storage device, the further processing structure corresponds to the standard structure which has already been described with reference to FIG. 3.

Consequently, the possibility of an unauthorised intervening printer control system PCₐ being coupled in the area of the printer interface also arises in a structure according to FIG. 4 by analogy with the explanations to FIG. 3. However, it is also possible for an intervention of such an unauthorised system PCₐ to be made in the LAN or internet connection between the personalisation server sub-centre PSS and the control system PC for the printer D in the personalising device V. This possibility has not been described and shown with reference to FIG. 3 to increase the clarity of this structural diagram. Nevertheless, it could also be carried out in FIG. 3. Whereas in the first possibility for unauthorised intervention, the authorised control system PC is replaced, in the second intervention possibility the existence of a manipulated central distribution point PSSₐ would be produced to deceive the following processing system. In both cases, forged data can be fed in the attacking system by decoupling or suppressing the authorised data path. Despite the prescribed rules, these data are then correspondingly processed to produce identity documents. In the embodiment according to FIG. 4, for example, forged data of this type can be created by copying parts of the unambiguously defined and unique number and/or code space in a process step CP. Then any predefinable personal data and additional information can be added to this copied data by the unauthorised position PCₐ.

Thus, possible examples of an improper external control to produce security documents which comply with all the regulations using known personalising devices V have been described with reference to FIGS. 3 and 4 using known methods and devices.

These variants of improper external control during the production of security documents is particularly very critical in the production of machine-readable travel documents, so-called machine readable passports MRPs. These identity documents have been standardised by the International Civil Aviation Organisation, ICAO for short, with about 188 member countries worldwide. As a result of further increased security requirements, smart card chips will also be integrated in MRPs in the near future, e.g. in the form of RFID chips. At least with this step the known personal travel document will have become a complex e-passport. Even without this electronic component however, the modern security document imposes higher requirements with regard to its personalisation and production environment than can be satisfied by known devices.

Thus, according to the invention, the printer D itself is equipped with an intelligence I to ward off the improper interventions described previously. The printer D is individually trained to carry out an authorisation check for each print order by the intelligence I as an integral part. Within the framework of each authorisation check, an authorisation enquiry A is sent out by the intelligence I for each print order received individually at the printer D. In the present exemplary case, the authorisation enquiry A is directed to the personalisation server sub-centre PSS. The personalisation server sub-centre PSS must respond to this authorisation enquiry A with a reply R which is then checked together with the authorisation enquiry A by the intelligence I inside the printer D. A respectively pending individual print order is only executed by the printer D in the event of a positive test result. Should the check be negative, the print order is rejected by the printer D and not executed.

The structure known per se from FIG. 3 is thus extended with important functions by means of software. This software is substantially installed in the personalisation server sub-centre PSS as a server computer. However, said software intervenes in the entire production sequence of a security document from the boundary G between the decision maker HE or a government and the units which subsequently implement the print orders to a printer D. This software is therefore called a security suite which is implemented portably on various hardware platforms. The software is roughly divided into four areas: a personalisation management system, a personalisation control, a support module for a life cycle management and finally a key management. These components may also be available in multiple parallel chains.

Among other things, the personalisation management system causes both hardware and also software within the entire system to be authorised after every restart of the system or of a part thereof. This security check avoids any infiltration of incorrect or unauthorised components.

The personalisation control ensures that only authorised print commands can be carried out to create security documents. This eliminates operating staff from being able to have any influence on the creation of security documents, in particular a certain person cannot be allocated to any blank document manually. The personalisation control is thus a very important component of a computer program product according to the invention. This important function is explained in detail hereinafter with reference to the diagrams in FIGS. 1, 2 and 5.

The lifecycle management allows accurate monitoring and status detection for all security documents from production, during use up to the defined disposal.

The key management provides an adjustment to the keys or encryptions used between the system components. Keys are also created with a key hierarchy. This further increases the security of the encryption compared with a simple key creation.

The block diagram in FIG. 1 shows a coupling of the printer D via the intelligence I to the personalisation server sub-centre PSS via a LAN or internet connection L. Authorised data also reach the control system PC via the LAN or internet connection L and are sent back from there in prepared form to the printer D. As has already been shown in the embodiment from FIG. 4, an attempt can also be made here to attack the data structure by coupling in an unauthorised printer control system PCₐ via the LAN or internet connection L. In this case, however, the intelligence I further attempts to send authorisation enquiries A to the authorised personalisation server sub-centre PSS via this data line L in order to receive replies R to the unauthorised print order from there in a corresponding manner. Since in the present embodiment an incoming print order to the printer D is the trigger for the intelligence I to start an authorisation process, print orders which originate from the non-authorised printer control system PCₐ are not known to the personalisation server sub-centre PSS and cannot trigger any suitable reply R there. On the basis of an incorrect or even completely absent reply R, such print orders are immediately recognised as unauthorised and not executed by the printer D because they are immediately declined by the intelligence I.

Naturally, no separate lines are required for sending and receiving the authorisation enquiries A and replies R required in the course of the authorisation process to the personalisation server sub-centre PSS or the decision maker HE. Rather, in the present embodiment intrinsic channels inside the transmission section L are used. The graphical representation of these signals in FIG. 1 is merely used for an overview by showing individual process components as spatially separate.

In the first embodiment of the invention according to FIG. 1, the intelligence I in the printer D is protected against external access by a closed arrangement. In a second embodiment of the invention according to the diagram in FIG. 2, the control system PC for the printer D together with the printer D and the intelligence I are arranged in a closed unit. Thus, a printer interface DS can no longer be accessed from outside, as it was still possible in the embodiment according to the prior art as shown in FIG. 3. In the exemplary embodiment according to FIG. 2, the intelligence I is connected upstream of the control system PC for the printer D whereby an unauthorised functional access to the printer D can only be started outside the encapsulated unit around the printer D via the LAN or internet access L. An attempt at this could involve an unauthorised personalisation server sub-centre PSSₐ being inserted. As has already been described with reference to the embodiment in FIG. 1, this attempt of an unauthorised print control of the printer D also fails because the authorisation enquiry A is triggered by the intelligence I on receipt of an unauthorised print order and is not directed to the personalisation server sub-centre PSS or the decision maker HE and consequently cannot be answered in the form of a correct reply R. Thus, unauthorised print orders are reliably recognised as such and already rejected before processing by the control system PC of the printer D.

As an additional security feature, in addition to the encapsulated unit comprising printer D, control system PC and intelligence I, the personalising device V also comprises storage devices in the form of secured modules. Prepared security documents with relevant supply means are stored in a secured storage device C_{Ic} in the form of a safe. The ready-processed security documents from the printer D are finally stored in a storage safe C_{0c} with relevant closed transportation means.

Thus, the personalising device V according to the diagram of FIG. 2 now comprises three modules protected against unauthorised access, also comprising mechanical protection. Handling during supply of material as well as the removal of material in the form of finished security documents is hereby ultimately considerably simplified. In particular, in one embodiment the individualised passports stored in the secured storage device C_{Ic} and/or certain number and/or code spaces for these passports are known.

In particular, special security precautions and/or alarm measures can be taken in the event that one of the three previously mentioned modules C_{Ic}, D, C_{0c}, each secured by itself, has been opened without authorisation during operation or during a fault. In particular, the destruction of the data sets for which processing has not yet been completed is ordered with the ejection and/or destruction of the security document which has just been processed. Furthermore, all log files on completed security documents can be destroyed so that no information on code and/or number spaces used for completed security documents is entrusted to unauthorised parties.

In the course of an individualisation of prefabricated passport documents, each passport receives at least one continuous number or another identifier. When a passport document prepared in this way is fed into the printer D, at least one of these identifiers is read out so that it is available in the printer D. In the present exemplary embodiment, this identifier of a prepared passport document respectively pending for printing is sent within the framework of the structure of an authorisation enquiry A. This identifier must be known in the personalisation server sub-centre PSS since it must be a member of a previously released and therefore known number or code space. Here, a decision is now made and archived relating to an allocation of the data of a person to the data of a passport document. The information on the decision which has been made can subsequently be sent in the form of a reply R to the printer D in the personalising device V to start the print order itself. In an alternative embodiment, this allocation decision is shifted into the particularly secured area of the decision maker HE. Accordingly, in this case, the authorisation enquiries A are now directed from the printer D to the decision maker HE from which a reply R is then sent back to the printer D in response to the authorisation enquiry A.

The boundary G between the decision maker or a government towards the units which subsequently execute the print orders, which is also contained in the exemplary embodiments of FIGS. 1 and 2, is formed according to the invention by a computer which is not shown further in the diagrams. This computer takes over the function of a proxy server. Its main function is to make an adjustment between an individual port with respect to software, data formats, databases, encryption etc. to a decision maker or a government on the one hand and a standardised system on the other hand. According to the application, an adaptation of a device according to the invention to a respective decision maker HE or its structure is only to be made at this point G. The remaining system remains unaffected by these adaptation measures, whereby in particular an error search e.g. in the software is simplified quite substantially.

Furthermore, in the exemplary embodiments in FIGS. 1 and 2 a key management KM and a life cycle management LCM are localised at the decision maker HE. The decision maker HE thus centrally determines all parameters of the encryption for all subordinated units in the production of security documents. In addition, the decision maker HE logs the entire life path of a security document from the provision of the respective key and other security components over issuing and use to its defined destruction after the validity has expired. Thus, in addition to all the security documents issued at that time, all the excluded security documents which were never issued because of production errors or other defects can be retrieved at any time at the decision maker HE.

FIG. 5 shows an exemplary embodiment of a sequence of a mutual recognition of the system components involved up to the issuing of a finished security document, in this case a passport. In a first step 1, an authentication is made between the printer D, the personalisation server sub-centre PSS and the decision maker HE. The authorised elements involved are thus known among one another. Such a process is regularly carried out on the basis of sending symmetrically or asymmetrically encrypted messages and is known per se from the prior art.

In step 2 an enquiry/order for printing a passport is received at the printer D, the personalisation server sub-centre PSS or the decision maker HE. This print enquiry Ordr triggers an authorisation enquiry A in the intelligence I of the printer D which is sent to the decision maker HE in step 3. This is also checked when a print enquiry Ordr is received otherwise. If this is a non-authorised enquiry for printing an identity document, in the present example a negative acknowledgement or answer NAK is issued by the decision maker HE. The process then has its defined end in step 4 since the print enquiry which is recognised as unauthorised is discontinued. Otherwise, a reply R is created as a positive acknowledgement and sent.

In step 5 a number Pass# of a respective prepared individualised passport pending for printing, which has been read in the printer D, is interlinked together with personal data P_Data available in the decision maker HE. Thus, in step 5 a link is made between a respective passport number Pass# and a person by means of the relevant data sets P_Data either in the decision maker HE or in the personalisation server sub-centre PSS. Subsequently, in step 6 a print template is created by the personalisation server sub-centre PSS. Furthermore, log files LOG provided with time stamps are created in step 6 and secured in the database DATA in the decision maker HE.

In step 7 a finished print template, in signed form and provided with a time stamp, is received by the control system PC for the printer D and passed to the printer D in prepared form. In step 8 the printer D now prints by means of the print template onto the passport security document which has previously been identified by means of its number Pass#.

In a step 9 the time and place of the completed passport process is notified and issued by the printer D via the information path to the database DATA in the decision maker HE. Otherwise, an error message is issued. In step 10 the print order is processed and the passport is completed and issued.

The data lines described previously as connections between the individual function blocks are always operated using security and coding methods. In particular during the transition from the personalisation server sub-centre PSS to the control system PC for the printer D an additional coding is used to increase the data security. In the present exemplary embodiment, private key/public key coding methods are preferably used as coding methods. In the immediate surroundings of the personalising device V, additional security measures can even be downgraded since the existing interfaces can be optimally secured against unauthorised external access. The operating staff on site at the personalising device V can only issue passports which have been produced in an authorised manner.

1: A method for producing personalized identification documents, wherein a personalized identification document is provided with at least one from a plurality of different security features by printing, embossing, laser treatment or similar methods performed by a device incorporating printing capabilities (D), characterised in that
the at least one printer (D) only executes a print order (Ordr) after receiving a reply (R) to at least one verification enquiry (A) whose correctness is confirmed and
a link is made between the personalized identification document to be printed and relevant data sets from outside the printer (D) and
subsequently a print template is created by a personalisation server sub-centre (PSS) and
this print template is sent to the printer (D).

2: The method according to claim 1, characterised in that the verification enquiry (A) is triggered by an intelligence (I) in the printer (D).

3: The method according to claim 1,
characterised in that the verification enquiry (A) is checked at the personalisation server sub-centre (PSS) or at the decision maker (HE) and a corresponding reply (R) is dispatched.

4: The method according to claim 1, characterised in that the reply (R) together with the authorisation enquiry (A) is checked by the intelligence (I) inside the printer (D).

5: The method according to claim 1, characterised in that security precautions and/or alarm measures are taken in the event that one of the components embodied as secured modules (C_{Ic}, D, C_{0c}) around the printer (D) or in contact with the printer (D) is opened without authorisation during operation or during a fault.

6: A device for producing personalized identification documents, wherein a decision maker (HE) and at least one device incorporating printing capabilities (D) are connected to one another, characterised in that
it is embodied to implement a method according to one or more of the preceding claims, wherein at least one printer (D) is provided with intelligence (I) for triggering an authorisation enquiry (A) in response to an incoming print order (Ordr) and
the decision maker (HE) communicates with the printer (D) via a personalisation server sub-centre (PSS), where the personalisation server sub-centre (PSS) is provided for subsequent creation of a print template by linking the personalized identification document to be printed and relevant data sets from outside the printer (D) in case of confirmation of correctness of a verification enquiry (A).

7: The device according to claim 6, characterised in that the intelligence (I) is embodied as means for checking an authorisation for granting a print order.

8: The device according to claim 6, characterised in that the personalisation device (V) comprises an encapsulated unit comprising printer (D), control system (PC) and intelligence (I).

9: The device according to claim 6, characterised in that the storage devices around the printer (D) are embodied as secured modules (C_{Ic}, C_{0c}).

10: The device according to claim 6, characterised in that a boundary (G) between a decision maker (HE) towards the units which subsequently execute the print orders is formed by a computer, in particular by a proxy server.

11: A computer program product for controlling a method for producing personalized identification documents, wherein
a personalized identification document is provided with at least one from a plurality of different security features by printing, embossing, laser treatment or similar methods, wherein a decision maker (HE) communicates with at least one individualisation or personalisation device incorporating printing capabilities (D), characterised in that, after loading into a random access memory of a data processing system which can also comprise distributed external components, it enables this data processing system to execute a method in which each incoming print order (Ordr) for producing a personalized identification document is checked with regard to its authorisation, in particular by checking that a receipt of a reply (R) received to at least one verification or authorisation enquiry (A) is correct and subsequently a print template is created in a personalisation server sub-centre (PSS) creating a link between the personalized identification document to be printed and relevant data sets from outside the printer (D) and sending this print template to the printer (D).
